(19) United States
(12) Patent Application Publication
(10) Pub. No.: US 2011/0080429 A1
(43) Pub. Date: Apr. 7, 2011

(54) OVERCOMING A DISPLAY UNIT RESOLUTION LIMIT IN A COMPUTING DEVICE

(76) Inventor: Makarand Damle, Pune (IN)

(21) Appl. No.: 12/573,964

(22) Filed: Oct. 6, 2009

(51) Int. Cl. G09G 5/00; G06T 1/00

(52) U.S. Cl. 345/660; 345/698; 345/522

(57) ABSTRACT

A method includes preventing a filtering of a display attribute outside a range of values of a native display attribute compatible with a display unit of a computing device during loading of a display driver of the display unit on the computing device. The method also includes rendering a multimedia application having a display attribute outside the range of values of the native display attribute on the display unit.

### FIELD OF TECHNOLOGY

This disclosure relates generally to display attributes of multimedia applications to be rendered on a display unit and, more particularly, to overcoming a display unit resolution limit in rendering the aforementioned multimedia applications on the display unit in a computing device.

### BACKGROUND

A majority of multimedia applications (e.g., three-dimensional (3-D) games) may require active resolutions in excess of 800×600. Some computers (e.g., low-end notebooks) may include small display units that only support resolutions less than 800×600. Therefore, the aforementioned display units may not natively support resolutions required by the majority of multimedia applications.

Rendering multimedia across multiple display units has been utilized to overcome resolution limits. Therefore, overcoming resolution limits of a computer device may involve the inconvenient utilization of multiple display units.

### SUMMARY

A system, an apparatus, and a method of overcoming a display unit resolution limit in a computing device are disclosed. In an aspect, a method includes preventing a filtering of a display attribute outside a range of values of a native display attribute compatible with a display unit of a computing device during loading of a display driver of the display unit on the computing device. The method also includes rendering a multimedia application having a display attribute outside the range of values of the native display attribute on the display unit.

In another aspect, a method includes transmitting an identification data of a display unit of a computing device to one or more of a display driver of the display unit and an operating system of the computing device. The method also includes preventing a filtering of a display attribute outside a range of values of a native display attribute compatible with the display unit included in the identification data of the display unit during loading of the display driver on the computing device. In addition, the method includes scaling the display attribute outside the range of values of the native display attribute to a display attribute within the range of values of the native display attribute.

In yet another aspect, a computing device includes a display unit, a display driver associated with the display unit, and a multimedia processor. A filtering of a display attribute outside a range of values of a native display attribute compatible with the display unit is prevented during a loading of the display driver on the computing device. Scaling of the display attribute outside the range of values of the native display attribute to a display attribute within the range of values of the native display attribute is accomplished using the multimedia processor.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the Figures of the accompanying drawings, in which like references indicate similar elements and in which:

FIG. 1 is a process flow illustrating a method of preventing a filtering of a display attribute multimedia application in a computing device, according to one or more embodiments.

FIG. 2 is a process flow illustrating a method of providing a capability to a display unit of supporting a display attribute of a multimedia application outside a range of values of a native display attribute compatible with the display unit, according to one or more embodiments.

FIG. 3 is a system view of a computing device, according to one or more embodiments.

FIG. 4 is a system view of a computing device illustrating the rendering of a multimedia application utilizing an analogy, according to one or more embodiments.

FIG. 5 is a diagrammatic system view of a data processing system in which any of the embodiments disclosed herein may be performed, according to one or more embodiments.

Other features of the present embodiments will be apparent from the accompanying drawings and from the detailed description that follows.

### DETAILED DESCRIPTION

A system, an apparatus, and a method of overcoming a display unit resolution limit in a computing device are disclosed. In the following description, for the purposes of explanation, numerous specific details are set forth in order to provide a thorough understanding of the various embodiments. It may be evident, however, to one skilled in the art that the various embodiments may be practiced without these specific details.

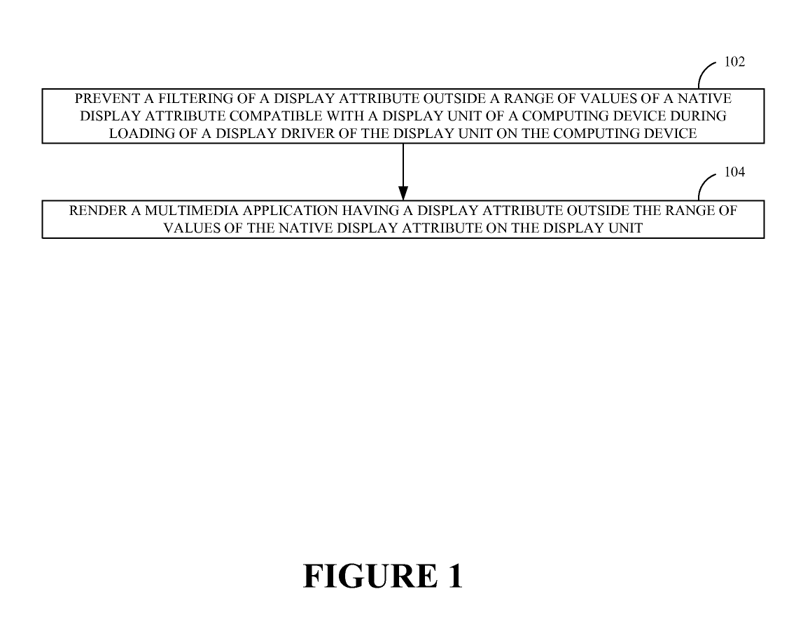

FIG. 1 is a process flow illustrating a method of preventing a filtering of a display attribute of a multimedia application in a computing device, according to one or more embodiments. In one or more embodiments, the display unit of the computing device may have a native display attribute suitable for rendering a multimedia application (e.g., a computer game). In one or more embodiments, the display unit of the computing device may be compatible with a range of values of the native display attribute. In one or more embodiments, the display attribute may be a display resolution.

In operation 102, a filtering of the display attribute outside the range of values of the native display attribute compatible with the display unit of the computing device may be prevented during loading of a display driver of the display unit. In one or more embodiments, the filtering of the display attribute may be prevented by turning off the filtering associated with the operating system of the computing device and/or setting the timing associated with the range of values of the native display attribute as the timing associated with the display attribute outside the range of values of the native display attribute.

In one or more embodiments, an identification data of the display unit may be stored in a memory associated with the display unit. In one or more embodiments, the memory may be a programmable read-only memory that is compatible with a serial channel (e.g., I²C bus) for transmitting the identification data. In one or more embodiments, the identification data of the display unit may be interpreted by the display driver and an operating system of the computing device and, therefore, the information about the display attribute compatible with the display unit may be available to the display driver and the operating system. In other words, the identification data provided by the display unit may be transmitted to the display driver and/or the operating system. In one or more embodiments, the identification data may be an Extended Display Identification Data (EDID). The EDID may provide display unit related information such as manufacturer name, serial number, product type, display resolutions supported, timings supported by the display, and luminance data. In one or more embodiments, the EDID may be in a hexadecimal format. In one or more embodiments, the display driver and the operating system may build a list of modes that may be supported on the display unit (e.g., display panel) based on the range of values of the native display attribute advertised in the EDID.

In one or more embodiments, setting the timing associated with the range of values of the native display attribute as the timing associated with the display attribute outside the range of values of the native display attribute may involve scaling the display attribute outside the range of values of the native display attribute to a display attribute within the range of values of the native display attribute. In one or more embodiments, scaling the display attribute outside the range of values of the native display attribute may involve a buffer memory mapping between a buffer memory associated with the display attribute outside the range of values of the native display attribute to a buffer memory associated with the display attribute within the range of values of the native display attribute.

For example, in a computing system including a display unit having a native display resolution of 1024×576, filtering of a resolution of 800×600 may be prevented by setting a timing associated with the 1024×576 resolution as the timing associated with the 800×600 resolution. Such a setting of the timing may be accomplished by mapping a buffer memory associated with the 1024×576 resolution onto a buffer memory associated with the 800×600 resolution. In one or more embodiments, in operating systems such as Windows XP®, the operating system mode filtering may be turned off in the display driver of the display unit. In one or more embodiments, in operating systems such as Windows Vista® and Windows 7®, the timing associated with the native resolution may be reported as the timing associated with a target resolution to prevent the target resolution from being filtered by the operating system.

In one or more embodiments, display attributes outside the range of values of the native display attribute may be scaled using a scalar multimedia processor to generate a signal (e.g., Low-Voltage Differential Signaling (LVDS) signal) that matches the timing associated with the range of values of the native display attribute. In one or more embodiments, the scalar multimedia processor may be a Graphics Processing Unit (GPU). In one or more embodiments, damage to the display unit may be prevented in addition to providing a capability to the display unit to support display attributes outside the range of values of the native display attribute.

In one or more embodiments, when the operating system of the computing device is booted, the display driver may be queried by the operating system for the display attributes of the display unit of the computing device. In one or more embodiments, the display attributes outside the range of values of the native display attribute may be exposed due to the prevention of the filtering in operation 102. In one or more embodiments, an exposed display attribute outside the range of values of the native display attribute may be selected as a user mode to render a multimedia application on the display unit.

In one or more embodiments, operation 104 may involve rendering a multimedia application having a display attribute outside the range of values of the native display attribute on the display unit. Therefore, in one or more embodiments, preventing of the filtering of display attributes not compatible with the display unit may provide a capability to the display unit to render a multimedia application with a display attribute not compatible with the display unit.

In one or more embodiments, the multimedia application (e.g., a computer game) requiring a high display resolution may be rendered on the display unit of a low-end computer.

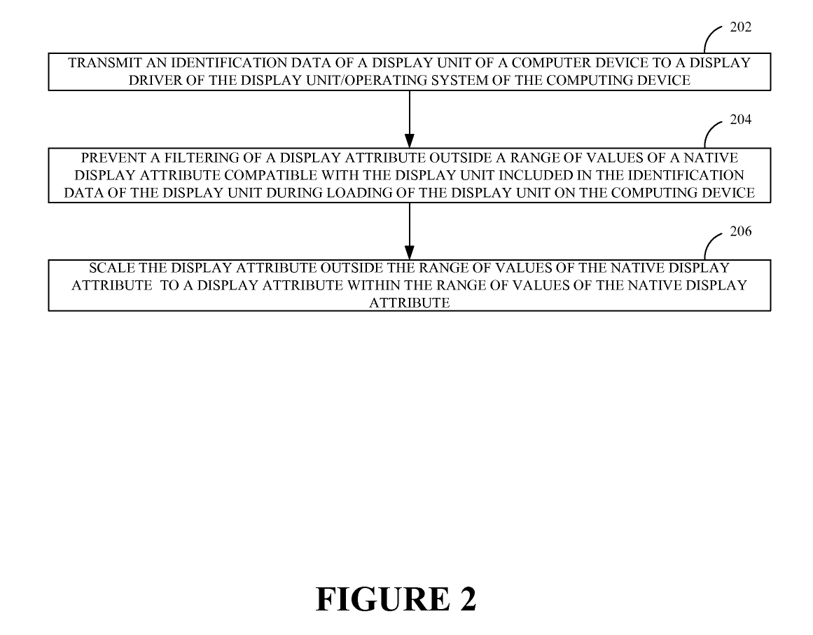

FIG. 2 is a process flow illustrating a method of providing a capability to a display unit of supporting a display attribute of a multimedia application outside a range of values of a native display attribute compatible with the display unit, according to one or more embodiments.

In one or more embodiments, in operation 202, an identification data of a display unit of a computing device may be transmitted to a display driver of the display unit and/or an operating system of the computing device. In one or more embodiments, as discussed above, the identification data may be an EDID of the display unit.

In one or more embodiments, in operation 204, filtering of a display attribute outside the range of values of the native display attribute compatible with the display unit included in the identification data may be prevented during loading of the display driver of the display unit on the computing device. In one or more embodiments, when a multimedia application (e.g., computer game) may be provided to the computing device, a display attribute (e.g., display resolution) of the multimedia application may be compared to the native display attribute included in the identification data provided associated with the display unit. In one embodiment, the range of values of the native display attribute may be in the form of a table of modes including timings associated with display attributes. In one or more embodiments, when the display attribute of the multimedia application exceeds the range of values of the native display attribute, the filtering of the display attribute may be prevented as described above with reference to operation 102 of FIG. 1.

In one or more embodiments, in operation 206, the display attribute outside the range of values of the native display attribute of the display unit may be scaled to a display attribute within the range of values of the native display attribute (see also the description associated with operation 102 of FIG. 1). In one or more embodiments, such a scaling may provide a capability to the display unit to render a multimedia application having display attributes outside the range of values of the native display attribute compatible with the display unit.

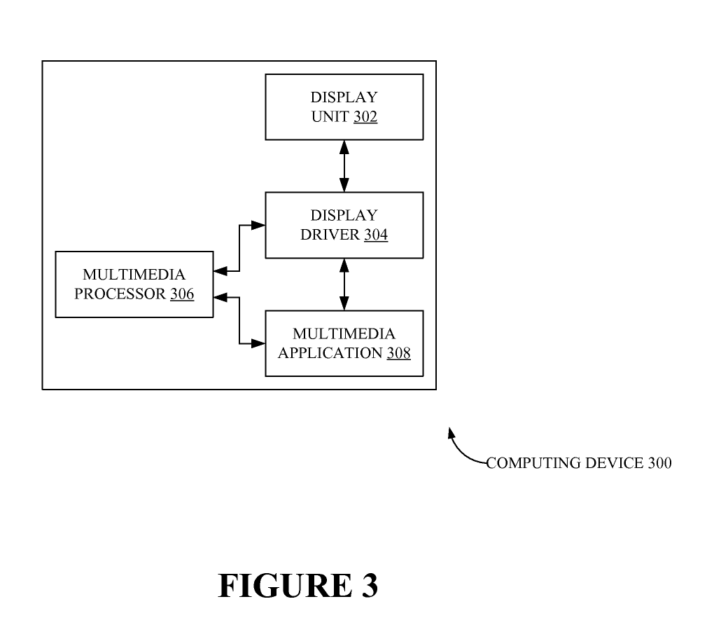

FIG. 3 is a system view of a computing device 300, according to one or more embodiments. In one or more embodiments, a computing device 300 may include a display unit 302 and a display driver 304 associated with the display unit 302. In one or more embodiments, filtering of a display attribute (e.g., display resolution) outside the range of values of the native display attribute compatible with the display unit 302 may be prevented during the loading of the display driver 304 on the computing device 300. In one or more embodiments, a multimedia processor 306, with the aid of the display driver 304, may scale the display attribute outside the range of values of the native display attribute to a display attribute within the range of values of the display attribute. In one or more embodiments, the display unit 302 may be a computer monitor or a display panel of a notebook computer. In one or more embodiments, the display unit 302 may render a multimedia application 308 having a display attribute outside the range of values of the native display attribute of the display unit 302. In one or more embodiment, the multimedia processor 306 may be a scalar multimedia processor (e.g., a scalar GPU).

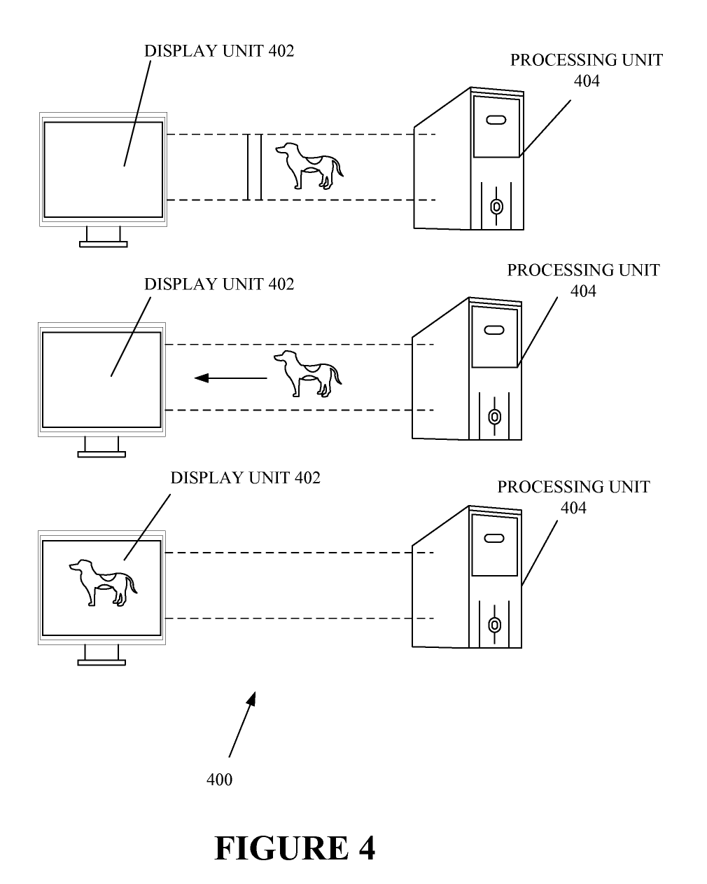

FIG. 4 is a system view of a computing device 400 illustrating the rendering of a multimedia application utilizing an analogy, in accordance with one or more embodiments. In one or more embodiments, the computing device 400 may include a display unit 402 and a processing unit 404. In one or more embodiments, a filtering of a display attribute outside a range of values of a native display attribute compatible with the display unit 402 (analogously shown as a dog being prevented from crossing the channel from the processing unit 404 to the display unit 402) may be prevented (analogously shown as the path of the dog to the display unit 402 being cleared) during loading of a display driver of the display unit 402 on the computing device 400. In one or more embodiments, a multimedia application (e.g., a computer game) having a display attribute outside the range of values of the native display attribute of the display unit may be loaded onto a disk drive (e.g. compact disc drive) in the processing unit 404. In one or more embodiments, the multimedia application may be rendered on the display unit 402 (analogously shown as the dog being on a screen of the display unit 402).

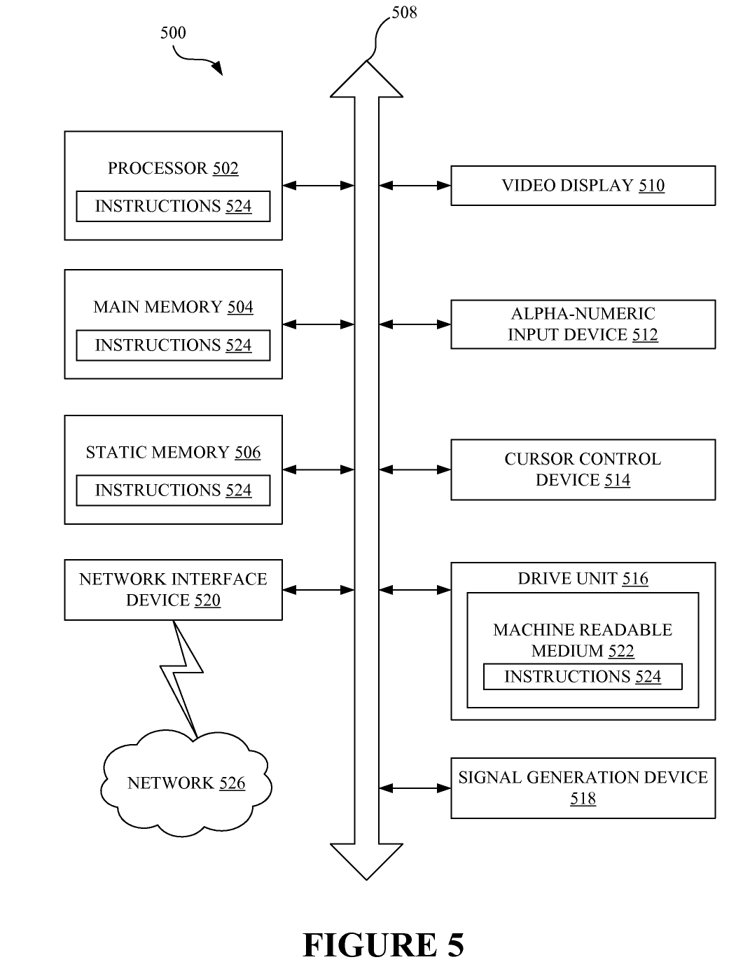

FIG. 5 is a diagrammatic system view 500 of a data processing system in which any of the embodiments disclosed herein may be performed, according to one or more embodiments.

The diagrammatic system view 500 may indicate a personal computer and/or the data processing system in which one or more operations disclosed herein are performed. The processor 502 may be a microprocessor, a state machine, an application specific integrated circuit, a field programmable gate array, etc. (e.g., Intel® Pentium® processor). The main memory 504 may be a dynamic random access memory (RAM) and/or a primary memory of a computer system.

The static memory 506 may be a hard drive, a flash drive, and/or other memory information associated with the data processing system. The bus 508 may be an interconnection between various circuits and/or structures of the data processing system. The video display 510 may provide graphical representation of information on the data processing system. The alpha-numeric input device 512 may be a keypad, a keyboard and/or any other input device of text (e.g., a special device to aid the physically handicapped).

The cursor control device 514 may be a pointing device such as a mouse. The drive unit 516 may be the hard drive, a storage system, and/or other longer term storage subsystem. The signal generation device 518 may be a bios and/or a functional operating system of the data processing system. The network interface device 520 may be a device that performs interface functions such as code conversion, protocol conversion and/or buffering required for communication to and from the network 526. The machine readable medium 522 may provide instructions on which any of the methods disclosed herein may be performed. The instructions 524 may provide source code and/or data code to the processor 502 to enable any one or more operations disclosed herein.

Although the present embodiments have been described with reference to specific example embodiments, it will be evident that various modifications and changes may be made to these embodiments without departing from the broader spirit and scope of the various embodiments. For example, the multimedia application may be any application compatible with a display attribute outside the range of values of the native display attribute of the display unit (e.g., Digital Video Disc (DVD) player software, iPhoto® of Apple Computer, Inc., Home Theater Movie Launching System, and DVD writer). For example, the various devices and modules described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
preventing a filtering of a display attribute outside a range of values of a native display attribute compatible with a display unit of a computing device during loading of a display driver of the display unit on the computing device; and
rendering a multimedia application having a display attribute outside the range of values of the native display attribute on the display unit.

2. The method of claim 1, comprising preventing the filtering of the display attribute outside the range of values of the native display attribute through at least one of:
turning off a filtering associated with an operating system of the computing device in the display driver; and
setting a timing limit associated with the range of values of the native display attribute as the timing limit associated with the display attribute outside the range of values of the native display attribute.

3. The method of claim 1, wherein the multimedia application is a computer game.

4. The method of claim 1, wherein the display attribute is a display resolution.

5. The method of claim 2, wherein setting the timing limit associated with the display attribute outside the range of values of the native display attribute includes scaling the display attribute outside the range of values of the native display attribute to a display attribute within the range of values of the native display attribute.

6. The method of claim 2, further comprising querying the display driver using the operating system of the computing device to expose the display attribute outside the range of values of the native display attribute.

7. The method of claim 2, wherein the timing limit associated with the range of values of the native display attribute is included in an identification data provided by the display unit of the computing device.

8. The method of claim 5, comprising using a scalar multimedia processor to scale the display attribute outside the range of values of the native display attribute to generate a signal matching the timing limit associated with a display attribute within the range of values of the native display attribute.

9. The method of claim 5, wherein scaling the display attribute outside the range of values of the native display attribute to the display attribute within the range of values of the native display attribute includes a mapping between a buffer memory associated with the display attribute outside the range of values of the native display attribute to a buffer memory associated with the display attribute within the range of values of the native display attribute.

10. The method of claim 6, further comprising selecting the exposed display attribute outside the range of values of the native display attribute as a user mode to render the multimedia application on the display unit.

11. The method of claim 7, further comprising transmitting the identification data provided by the display unit of the computing device to at least one of the display driver and the operating system of the computing device.

12. The method of claim 8, wherein the scalar multimedia processor is a Graphics Processing Unit (GPU).

13. A method comprising:
transmitting an identification data of a display unit of a computing device to at least one of a display driver of the display unit and an operating system of the computing device;
preventing a filtering of a display attribute outside a range of values of a native display attribute compatible with the display unit included in the identification data of the display unit during loading of the display driver on the computing device; and
scaling the display attribute outside the range of values of the native display attribute to a display attribute within the range of values of the native display attribute.

14. The method of claim 13, further comprising providing a multimedia application having a display attribute outside the range of values of the native display attribute to be rendered on the display unit.

15. The method of claim 13, comprising preventing the filtering of the display attribute outside the range of values of the native display attribute through at least one of:
turning off a filtering associated with the operating system of the computing device in the display driver; and
setting a timing limit associated with the range of values of the native display attribute as the timing limit associated with the display attribute outside the range of values of the native display attribute.

16. The method of claim 13, wherein scaling the display attribute outside the range of values of the native display attribute to the display attribute within the range of values of the native display attribute includes a mapping between a buffer memory associated with the display attribute outside the range of values of the native display attribute to a buffer memory associated with the display attribute within the range of values of the native display attribute.

17. A computing device comprising:
a display unit;
a display driver associated with the display unit, wherein a filtering of a display attribute outside a range of values of a native display attribute compatible with the display unit is prevented during a loading of the display driver on the computing device; and
a multimedia processor to scale the display attribute outside the range of values of the native display attribute to a different display attribute within the range of values of the native display attribute.

18. The computing device of claim 17, wherein a multimedia application having a display attribute outside the range of values of the native display attribute is rendered on the display unit.

19. The computing device of claim 17, wherein the multimedia processor is a scalar Graphics Processing Unit (GPU).

20. The computing device of claim 17, wherein the display attribute is a display resolution, and wherein the multimedia application is a computer game.
